(19) United States
(12) Patent Application Publication
(10) Pub. No.: US 2018/0014049 A1
(43) Pub. Date: Jan. 11, 2018

(54) Orientation Based, Aspect Ratio Switching Video Playback System

(71) Applicant: Tastemade, Inc., Santa Monica, CA (US)

(72) Inventors: Jason Matthew Griffin, Austin, TX (US); John Robert Lemberger, Austin, TX (US)

(21) Appl. No.: 15/642,294

(22) Filed: Jul. 5, 2017

Related U.S. Application Data
(60) Provisional application No. 62/360,290, filed on Jul. 8, 2016.

(51) Int. Cl. H04N 21/2343; H04L 29/06

(52) U.S. Cl. CPC H04N 21/234372; H04L 65/601

(57) ABSTRACT

An orientation based, aspect-ratio switching video playback system selects from multiple video streams having corresponding content to automatically match the orientation of the device and play a version of the video filmed, produced and formatted for that orientation. Orientation changes may occur at any time during playback. When an orientation change is detected, the video playback system stores the current playback time, switches to the video stream optimized for the new orientation, and resumes playback from the stored playback time. Switching may be performed automatically and seamlessly to enable the viewer to continue watching the video in the new orientation, at the optimal aspect ratio for such orientation, using the full screen area without clipping any video content, and without interruption.

### RELATED APPLICATIONS

This application claims the benefit of U.S. Provisional Application No. 62/360,290 filed Jul. 8, 2016, which is incorporated by reference herein.

### BACKGROUND

### 1. Field of Art

The disclosure generally relates to the field of digital media, and more particularly to streaming video on a video streaming device (including mobile devices).

### 2. Description of the Related Art

In a conventional video player (such as an application on a handheld device), the video player typically rotates video content when the device orientation changes so that the orientation of the video content matches the orientation of the device. Because most video players stream from only one format of video and most of these videos have a rectangular aspect ratio, rotating the content may result in either portions of video content being clipped or portions of screen area being left unused when the video is not being viewed in its intended orientation.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates an example embodiment of a network environment for streaming video.

FIG. 2 illustrates example interfaces and orientations for viewing video on a video streaming device.

FIG. 3 illustrates a first example embodiment of a process for switching between videos in response to an orientation change.

FIG. 4 illustrates a second example embodiment of a process for switching between videos in response to an orientation change.

FIG. 5 illustrates an example embodiment of a computing system.

### DETAILED DESCRIPTION

The Figures (FIGS.) and the following description relate to various embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

An orientation based, aspect-ratio switching video playback system selects from multiple video streams having corresponding content to automatically match the orientation of the device and play a version of the video filmed and produced for that orientation. Orientation changes may occur at any time during playback. In one embodiment, when an orientation change is detected, the video playback system stores the current playback time, switches to the video stream optimized for the new orientation and resumes playback from the stored playback time. In another embodiment, a video player application requests video segments from a server at predefined time intervals, where each request is for a video segment that is filmed and formatted according to the last detected orientation. Switching may be performed automatically and seamlessly to enable the viewer to continue watching the video in the new orientation, at the optimal aspect ratio for such orientation, using the full screen area without clipping any video content, and without interruption.

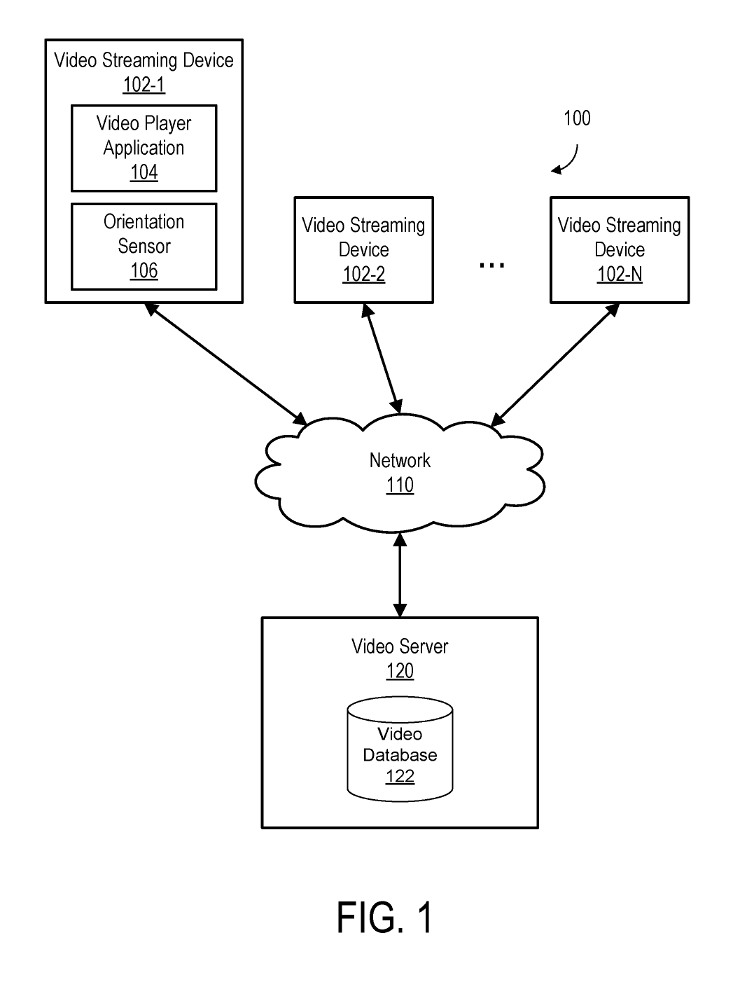

FIG. 1 illustrates an example video streaming environment 100. The video streaming environment 100 includes a network 110, video streaming devices 102 (e.g., video streaming devices 102-1, 102-2, . . . , 102-N), and a video server 120.

The video streaming devices 102 are generally any devices capable of receiving and presenting digital video content. Example video streaming devices 102 may include mobile devices such as smart phones, personal digital assistants, tablets, smart watches; Internet-connected televisions; or other display devices. A video streaming device 102 may execute a video player application 104 that receives and renders video for display on a display screen. The video player application 104 may provide various video playback controls for enabling a user to control playback of the video including, for example, a play control, pause control, stop control, rewind control, fast forward control, skip back control, skip forward control, volume control, various setting controls, and various content selection controls that enable the user to select video content from an available video library. The video streaming device 102 may furthermore include an orientation sensor 106 that senses the orientation of the video streaming device 102. For example, the orientation sensor 106 may detect whether the video streaming device 102 is in a portrait orientation relative to the ground (such that the shorter dimension of the video streaming device 102 makes a smaller angle with the ground than longer dimension) or a landscape orientation relative to the ground (such that the longer dimension of the video streaming device 102 makes a smaller angle with the ground than the shorter dimension). In one embodiment, the portrait orientation corresponds to a 9×16 aspect ratio and the landscape orientation corresponds to a 16×9 aspect ratio. In an embodiment, the orientation sensor 106 comprises an accelerometer that detects the orientation based on sensing changes in position of the video streaming device 102. As will be explained in further detail below, the video player application 104 may switch between different video streams having different aspect ratios depending on the change in orientation detected by the orientation sensor 106.

In an embodiment, the video streaming device 102 comprises a processor and a non-transitory computer-readable storage medium that stores instructions that when executed by the processor causes the processor to carry out the functions attributed to the video player application 104 or other processes described herein.

The video server 120 stores a plurality of videos in a video database 122 that may be accessed for viewing on the video streaming devices 102 via the network 110. In an embodiment, the video server 120 stores at least two different streams for any given content in which a first stream has an aspect ratio and editorial format suitable for viewing in a landscape orientation and a second stream has an aspect ratio and editorial format suitable for viewing in a portrait orientation. For example, the corresponding videos may be filmed concurrently and depict substantially the same scene or scenes during the same time or time frames. The video server 120 may communicate with the video streaming devices 102 to receive information indicating the orientation of the video streaming device 102 and the video server 120 may switch between providing the two different streams of the video content to the video streaming device 102 as the device 102 switches orientation. In an embodiment, the switch in streaming may occur seamlessly and in real-time during playback so that the aspect ratio matches the orientation of the video streaming device 102 at any given time. Furthermore, in one embodiment, the different streams of corresponding content in the different aspect ratios are each captured natively in their respective aspect ratios and no aspect ratio conversion is necessarily required. Thus, in one embodiment, the videos in the video database 122 are capturing by concurrently filming two versions, each with a different aspect ratio suitable for viewing in different orientations. Furthermore, after filming, the videos with different aspect ratios may be produced, edited, and formatted for viewing in their respective aspect ratios for an optimal viewing experience as intended by the filmographer. For example, text or other visual effects overlaid on the scene may also be placed and oriented in a manner suitable for the particular aspect ratio instead of producing only a single video and then performing an aspect ratio conversion. In other embodiments, the video server 120 may store additional streams that may be customized for displaying on screens having different sizes, aspect ratios, or resolutions. For example, streams corresponding to given video content may include a stream suitable for display on a television, on a laptop monitor, on a mobile device, or on a smart watch and may include streams suitable for multiple different orientations of each of these devices. Further still, streams may be made available that are natively captured and produced in an aspect ratio for a specific make and model of a device having a known aspect ratio. In these embodiments, a display device may request a stream from the video server 120 suitable for the particular device depending on its size, aspect ratio, and orientation.

In an embodiment, the video server 120 comprises a processor and a non-transitory computer-readable storage medium that stores instructions that when executed by the processor causes the processor to carry out the functions attributed to the video server 120 or other processes described herein.

The network 110 enables communications among the entities connected to them through one or more local-area networks and/or wide-area networks. In one embodiment, the network 110 is the Internet and uses standard wired and/or wireless communications technologies and/or protocols. The network 110 can include links using technologies such as Ethernet, 802.11, worldwide interoperability for microwave access (WiMAX), long term evolution (LTE), 3G, 4G, digital subscriber line (DSL), asynchronous transfer mode (ATM), InfiniBand, and/or PCI Express Advanced Switching. Similarly, the networking protocols used on the network 110 can include multiprotocol label switching (MPLS), transmission control protocol/Internet protocol (TCP/IP), User Datagram Protocol (UDP), hypertext transport protocol (HTTP), simple mail transfer protocol (SMTP), and/or file transfer protocol (FTP). The data exchanged over the network 110 can be represented using technologies and/or formats including hypertext markup language (HTML), extensible markup language (XML), and/or JavaScript Object Notation (JSON). In addition, all or some of the transmitted data can be encrypted using conventional encryption technologies such as the secure sockets layer (SSL), transport layer security (TLS), virtual private networks (VPNs), and/or Internet Protocol security (IPsec). In another embodiment, the entities use custom and/or dedicated data communications technologies instead of, or in addition to, the ones described above. Although one instance of the network 110 is shown, multiple networks may be present.

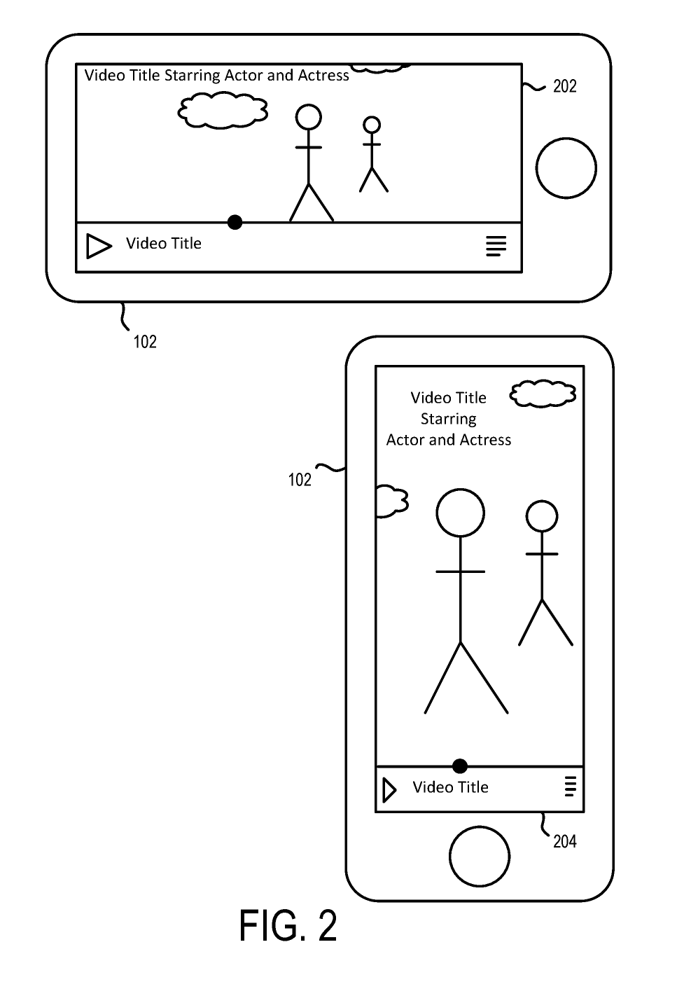

FIG. 2 illustrates an example landscape-oriented video player interface 202 and an example portrait-oriented video player interface 204 displayed on a video streaming device 102. The landscape-oriented video player interface 202 plays a video filmed and produced in the landscape aspect ratio. The portrait-oriented video player interface 204 plays a corresponding video having corresponding content that is filmed and produced in portrait aspect ratio. As the orientation of the video streaming device 102 changes, the video player application 104 may automatically switch between the landscape-oriented player interface 202 that plays the first video produced in the landscape aspect ratio and the portrait-oriented player interface 204 that plays the second video produced in the portrait aspect ratio. These transitions between videos may occur seamlessly so that the user can continue watching the video without interruption as the orientation changes. Furthermore, because the videos may each be natively captured in their respective aspect ratios (instead of being converted from one aspect ratio to another), the videos do not need to be rotated to match the orientation, and the videos do not need to be zoomed, stretched, clipped, or filled to fit the desired orientation. As a result, the displayed content may be optimized in both orientations, thereby providing a better experience for the viewer compared to traditional video players that rotate, clip, or stretch a video to fit the non-native orientation.

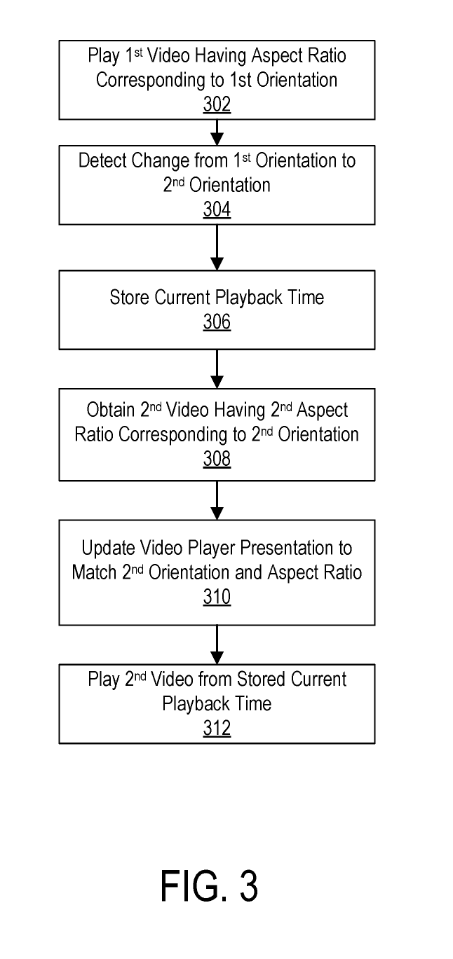

FIG. 3 illustrates an embodiment of a process for switching between video streams in response to an orientation change. The video player application 104 plays 302 a first video having a first aspect ratio corresponding to the initial orientation (e.g., a first orientation) of the video streaming device 102. During playback, the video player application 104 detects 304 a change in the orientation of the video streaming device 102 from the first orientation to a second orientation (e.g., from a portrait orientation to a landscape orientation or vice versa). For example, the video player application 104 may detect the change in response to a signal generated from the orientation sensor 106. In response to this detection, the video player application 104 stores 306 the current playback time to a memory (e.g., a buffer). The video player application 104 obtains 308 a second video having a second aspect ratio corresponding to the second orientation from the video server 120. The second video corresponds to the same content as the first video but is natively produced with a different aspect ratio for viewing in the different orientation. The video player application 104 updates 310 the video player presentation to correspond to the 2^{nd} orientation and plays 312 the second video from the stored playback time. This process may be similarly performed to switch from the second video back to the first video in response to detecting another change in orientation back to the initial orientation.

In one embodiment, the video player application 104 may pause or otherwise cease playback of the first video upon detecting the orientation change and immediately request the second video from the video server 120 to resume playback beginning at the stored playback time. Presuming network latency is sufficiently low, the pause time may be short enough that it is not perceivable to the viewer (e.g., the pause time is less than a frame period) so that the transition appears seamless.

Latency between orientation changes can be improved in several ways. In one embodiment, the orientation sensor 106 may be designed to provide hyper-advanced detection of an imminent change in orientation thereby enabling the video player application 104 to very quickly react to the change. For example, the orientation sensor 106 may predict when an orientation change will occur by sensing small motions indicative of an orientation change. For example, the orientation sensor 106 may detect an angular motion of the device 102 to determine when the device 102 begins to rotate. The device 102 may then request the second video from the server 120 when it can predict with a reasonable degree of certainty that an orientation change is imminent. For example, the device 102 may detect when the device 102 crosses a threshold angle (that may be less than half way between the first and second orientations) and the angular motion indicates that the device 102 is being rotated from the first orientation to the second orientation.

In an alternative embodiment, the video player application 104 may concurrently receive both the first and second videos corresponding to the different aspect ratios from the video server 120 but only display the video corresponding to the detected orientation. Frames of the non-displaying video may be cached for a predefined time period ahead of the current playback position (e.g., 1-2 seconds). Then when the change in orientation is detected, the video player application 104 can immediately switch to the other video stream by playing the cached frames. In this way, the video player application 104 can switch streams without having to wait to receive the new stream from the video server 120, thereby reducing or eliminating network latency.

In another alternative embodiment, playback of the video content may be primarily controlled by the video server 120 instead of the video player application 104 on the video streaming device 102. For example, in one embodiment, the video streaming device 102 sends a signal to the video server 120 indicating when an orientation change occurs and the video server 120 automatically pushes the appropriate video to the video streaming device 102 without the video streaming device 102 necessarily having to request it from the server 120. Furthermore, in alternative embodiments, the rendered video player interface may be streamed from the video server 120 instead of being loaded locally from the streaming device 102. When the video server 120 receives an indication that the orientation of the video streaming device 102 occurs, the video server 120 pushes the user interface to the video streaming device 102 in the new orientation.

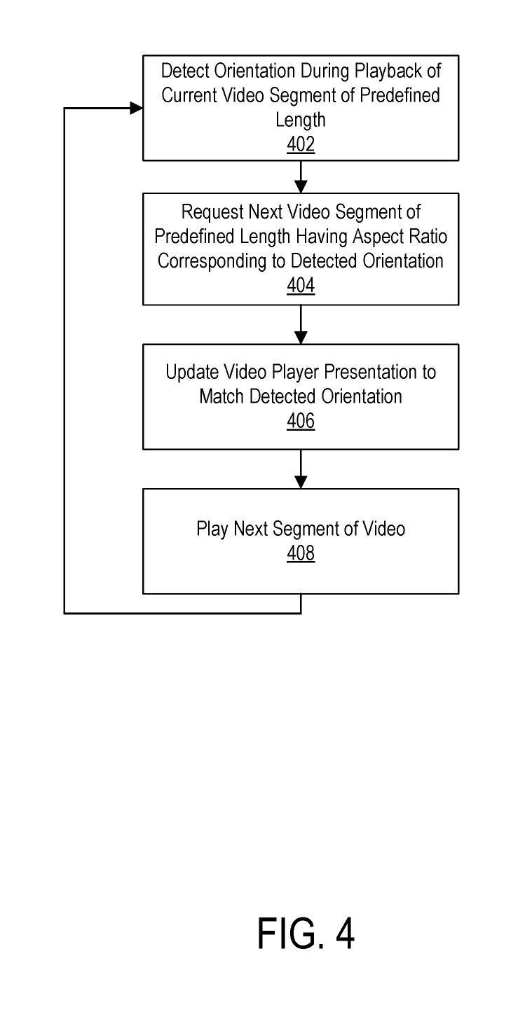

FIG. 4 illustrates another embodiment of a process for switching between video streams in response to an orientation change. In this embodiment, first and second videos corresponding to the same video content are stored at the video server 120. The first video is filmed and formatted in a first aspect ratio optimized for a first orientation of a video streaming device (e.g., a landscape orientation) and the second video is filmed and produced in a second aspect ratio optimized for a second orientation of a video streaming device 102 (e.g., a portrait orientation). The first and second video are each divided into segments of predefined length (e.g., one second segments, other fixed length segments, or variable-length segments) and each segment is stored at the server 120 and may be referenced by a unique reference identifier. During playback, the video streaming device 102 sequentially requests the segments from the video server 120 and plays the segments with appropriate timing. For example, streaming of a video segment begins immediately following the last frame of a prior segment such that playback transitions seamless between segments. The video streaming device 102 may temporarily buffer segments during playback of one or more prior segments so that each segment is available locally at the video streaming device 102 when it is time to play it. Optionally, the video player application 104 may store more than two videos, with different videos comprising the same video content but filmed and formatted for different orientations, resolutions, and/or bitrates.

In the process of FIG. 4, the video player application 104 detects 402 an orientation of the video streaming device 102 at a time before the video player application 104 is ready to request a segment for the next time interval of the video. The video player application 104 then requests 404 the next video segment from the server 120. The requested segment is selected based on the detected orientation. For example, when requesting a segment corresponding to a time interval t, the video player requests either the segment of the first video (having the first aspect ratio) corresponding to the time interval t or the segment of the second video (having the second aspect ratio) corresponding to the time interval t depending on the detected orientation. The video streaming device 102 may detect the orientation and send the request prior to the time interval t-1 for the currently playing segment ending to ensure that at least an initial portion of the segment corresponding to time interval t is already buffered at the streaming device 102 before the start of the time interval. The video player interface is updated 406 to match the detected orientation. The video player application plays 408 the requested video segment having the aspect ratio corresponding to the detected orientation. This process then repeats for each time interval such that a video segment corresponding to the most recent detected orientation is played for each time interval of the video.

In an embodiment in which the video server 120 has different segments with different resolutions and/or bit rates, the video player application 104 may furthermore periodically check the available network bandwidth and determine which of the segments to request at any given time interval depending on the current bandwidth availability. The segment formatted for the particular resolution and/or bitrate is then requested from the server 120 for the given time interval and played by the video streaming device 102.

The above-described methods enable streaming of video in an orientation that tracks the orientation of the viewing device. Using two different streams that are natively produced in the different possible orientations beneficially improves both visual quality (e.g., because the video is not stretched, cropped, or otherwise distorted) and improves performance of the playback device because it avoids the need for real-time image processing of the video signal to conform it to a non-native orientation. Furthermore, latency during transitions can be beneficially reduced using the techniques described above to avoid a significant delay when the device switches from one orientation to another.

### Example Machine Architecture

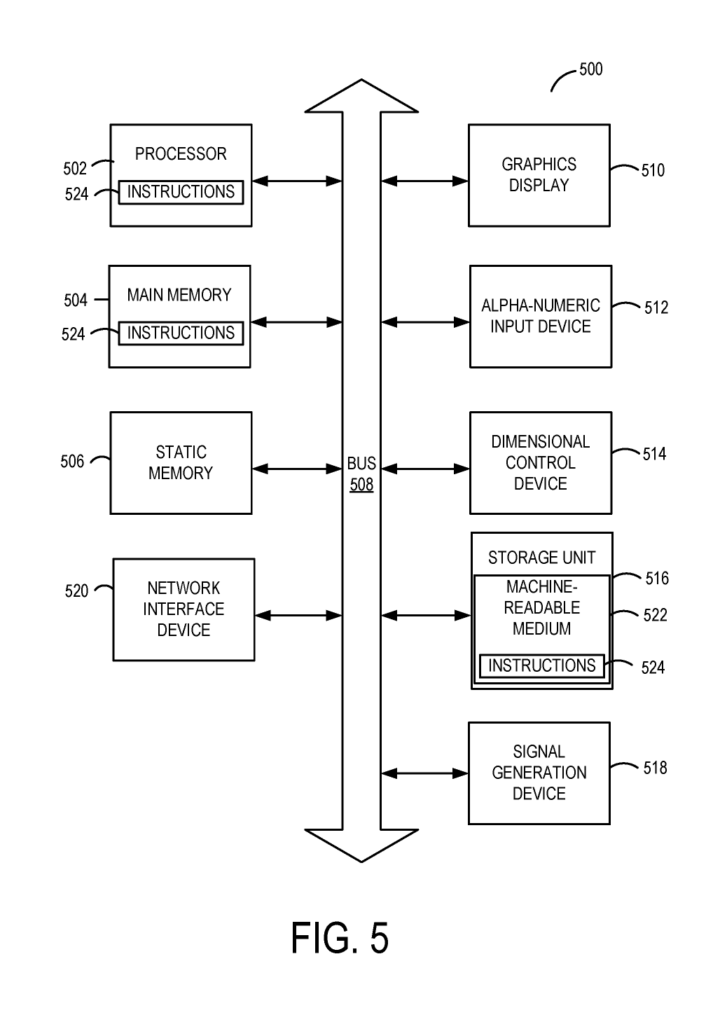

FIG. 5 is a block diagram illustrating components of an example computing system able to read instructions from a computer-readable medium and execute them in one or more processors (or controllers). The computing system in FIG. 5 may represent an implementation of, for example, the video streaming device 102 or the video server 120.

The computing system 500 can be used to execute instructions 524 (e.g., program code or software) for causing the computing system 500 to perform any one or more of the methodologies (or processes) described herein. In alternative embodiments, the computing system 500 operates as a standalone device or a connected (e.g., networked) device that connects to other computer systems. The computing system 500 in this example may comprise a video streaming device 102. In other examples, the computing system 500 may comprise, for example, a personal computer (PC), a tablet PC, a smart watch, or other device capable of executing instructions 524 (sequential or otherwise) that specify actions to be taken. In another embodiment, the computing system 500 may represent the video server 120. In a networked deployment, the computing system 500 may operate in the capacity of a video server 120 or a video streaming device 102 in a server-client network environment, or as a peer device in a peer-to-peer (or distributed) network environment. Further, while only a single computer system 500 is illustrated, a plurality of computing systems 500 may operate to jointly execute instructions 524 to perform any one or more of the methodologies discussed herein.

The example computing system 500 includes one or more processing units (generally processor 502). The processor 502 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computing system 500 also includes a main memory 504. The computing system 500 may include a storage unit 516. The processor 502, memory 504 and the storage unit 516 communicate via a bus 508.

In addition, the computing system 500 can include a static memory 506, a display driver 510 (e.g., to drive a plasma display panel (PDP), a liquid crystal display (LCD), or a projector). The computing system 500 may also include input/output devices, e.g., an alphanumeric input device 512 (e.g., touch screen-based keypad or an external input device such as a keyboard), a dimensional (e.g., 2-D or 3-D) control device 514 (e.g., a touch screen or external input device such as a mouse, a trackball, a joystick, a motion sensor, or other pointing instrument), a signal generation device 518 (e.g., a speaker), and a network interface device 520, which also are configured to communicate via the bus 508. Embodiments of the computing system 500 corresponding to a video streaming device 102 may include a different configuration than an embodiment of the computing system 500 corresponding to the video server 120. For example, an embodiment corresponding to the video server 120 may include a larger storage unit 516, more memory 504, and a faster processor 502 but may lack the display driver 510, input device 512, and dimensional control device 514.

The storage unit 516 includes a computer-readable medium 311 on which is stored instructions 524 (e.g., software) embodying any one or more of the methodologies or functions described herein. The instructions 524 may also reside, completely or at least partially, within the main memory 504 or within the processor 502 (e.g., within a processor's cache memory) during execution thereof by the computing system 500, the main memory 504 and the processor 502 also constituting computer-readable media. The instructions 524 may be transmitted or received over a network 526 via the network interface device 520.

While computer-readable medium 522 is shown in an example embodiment to be a single medium, the term “computer-readable medium” should be taken to include a single medium or multiple media (e.g., a centralized or distributed database, or associated caches and servers) able to store the instructions 524. The term “computer -readable medium” shall also be taken to include any medium that is capable of storing instructions 524 for execution by the computing system 500 and that cause the computing system 500 to perform any one or more of the methodologies disclosed herein. The term “computer-readable medium” includes, but not be limited to, data repositories in the form of solid-state memories, optical media, and magnetic media.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for the embodiments herein through the disclosed principles. Thus, while particular embodiments and applications have been illustrated and described, it is to be understood that the disclosed embodiments are not limited to the precise construction and components disclosed herein. Various apparent modifications, changes, and variations may be made in the arrangement, operation and details of the method and apparatus disclosed herein without departing from the scope defined in the appended claims.

1. A method for playing video content on a video streaming device, the method comprising:
detecting a first orientation of the video streaming device;
playing a first video on the video streaming device, the first video natively produced in a first aspect ratio corresponding to the first orientation of the video streaming device;
while playing the first video, detecting a change from the first orientation to a second orientation of the video streaming device;
in response to detecting the change, storing a current playback time of the first video and playing a second video on the video streaming device beginning at the current playback time, the second video natively produced in a second aspect ratio corresponding to the second orientation of the video streaming device, and the first and second video having corresponding content.

2. The method of claim 1, wherein the first aspect ratio comprises a portrait aspect ratio and the second aspect ratio comprises a landscape aspect ratio.

3. The method of claim 1, wherein the first video and the second video are filmed concurrently and depict a same scene.

4. The method of claim 1, wherein playing the first video comprises rendering a video player interface on the video streaming device according to the first aspect ratio, and wherein playing the second video comprises rendering the video player interface on the video streaming device according to the second aspect ratio.

5. The method of claim 1, wherein detecting the change from the first orientation to the second orientation comprises:
detecting an angular motion of the video streaming device and an angle of the video streaming device; and
detecting the change from the first orientation to the second orientation when the motion indicates movement from the first orientation to the second orientation and the angle crosses a threshold angle.

6. The method of claim 1, further comprising:
while playing the first video, buffering in a memory buffer, a stream of the second video including a predefined interval in advance of a playback position of the first video; and
wherein playing the second video comprises reading the second video from the memory buffer.

7. The method of claim 1, further comprising:
in response to detecting the change, sending a request to a video server for the second video; and
receiving a stream of the second video from the video server.

8. The method of claim 1, further comprising:
in response to detecting the change, sending an indication of the detection to a video server; and
receiving a stream of the second video from the video server in response to sending the indication.

9. A non-transitory computer-readable storage medium storing instructions for playing video content on a video streaming device, the instructions when executed to cause the processor to perform steps including:
detecting a first orientation of the video streaming device;
playing a first video on the video streaming device, the first video natively produced in a first aspect ratio corresponding to the first orientation of the video streaming device;
while playing the first video, detecting a change from the first orientation to a second orientation of the video streaming device;
in response to detecting the change, storing a current playback time of the first video and playing a second video on the video streaming device beginning at the current playback time, the second video natively produced in a second aspect ratio corresponding to the second orientation of the video streaming device, and the first and second video having corresponding content.

10. The non-transitory computer-readable storage medium of claim 9, wherein the first aspect ratio comprises a portrait aspect ratio and the second aspect ratio comprises a landscape aspect ratio.

11. The non-transitory computer-readable storage medium of claim 9, wherein the first video and the second video are filmed concurrently and depict a same scene.

12. The non-transitory computer-readable storage medium of claim 9, wherein playing the first video comprises rendering a video player interface on the video streaming device according to the first aspect ratio, and wherein playing the second video comprises rendering the video player interface on the video streaming device according to the second aspect ratio.

13. The non-transitory computer-readable storage medium of claim 9, wherein detecting the change from the first orientation to the second orientation comprises:
detecting an angular motion of the video streaming device and an angle of the video streaming device; and
detecting the change from the first orientation to the second orientation when the motion indicates movement from the first orientation to the second orientation and the angle crosses a threshold angle.

14. The non-transitory computer-readable storage medium of claim 9, wherein the instructions when executed further cause the processor to perform steps including:
while playing the first video, buffering in a memory buffer, a stream of the second video including a predefined interval in advance of a playback position of the first video; and
wherein playing the second video comprises reading the second video from the memory buffer.

15. The non-transitory computer-readable storage medium of claim 9, wherein the instructions when executed further cause the processor to perform steps including:
in response to detecting the change, sending a request to a video server for the second video; and
receiving a stream of the second video from the video server.

16. The non-transitory computer-readable storage medium of claim 9, wherein the instructions when executed further cause the processor to perform steps including:
in response to detecting the change, sending an indication of the detection to a video server; and
receiving a stream of the second video from the video server in response to sending the indication.

17. A method for playing video content on a video streaming device, the method comprising:
detecting a first orientation of the video streaming device during playback of a first video segment during a first time interval;
requesting from a video server, a second video segment for playing during a second time interval following the first time interval, the second video segment filmed and formatted in a first aspect ratio corresponding to the first orientation;
playing the second video segment;
detecting a second orientation of the video streaming device during playback of a second video segment during the second time interval, the second orientation different than the first orientation;
requesting from a video server, a third video segment for playing during a third time interval following the second time interval, the third video segment filmed and formatted in a second aspect ratio corresponding to the second orientation; and
playing the third video segment.

18. The method of claim 17, wherein the first aspect ratio comprises a portrait aspect ratio and the second aspect ratio comprises a landscape aspect ratio.

19. The method of claim 17, wherein the second video segment is taken from a first sequence of video segments filmed and formatted in the first aspect ratio, and wherein the third video segment is taken from a second sequence of video segments filmed and formatted in the second aspect ratio, the first and second sequences of video segments filmed concurrently and depicting a same scene.

20. The method of claim 17, wherein playing the second video segment comprises rendering a video player interface on the video streaming device according to the first aspect ratio, and wherein playing the third video comprises rendering the video player interface on the video streaming device according to the second aspect ratio.
